(19) United States
(12) Patent Application Publication
(10) Pub. No.: US 2025/0011144 A1
(43) Pub. Date: Jan. 9, 2025

(54) LIFTING DEVICE

(71) Applicant: Flexcrane, Inc., Azle, TX (US)

(72) Inventor: Vitor Hugo Carneiro dos Santos Neves, MAIA (PT)

(73) Assignee: Flexcrane, Inc., Azle, TX (US)

(21) Appl. No.: 18/731,875

(22) Filed: Jun. 3, 2024

Related U.S. Application Data
(60) Provisional application No. 63/524,880, filed on Jul. 4, 2023.

(51) Int. Cl. B66D 3/16; B66D 3/02

(52) U.S. Cl. CPC B66D 3/16; B66D 3/02

(57) ABSTRACT

A hanging hand-driven chain hoist, is able to lift, sustain and lower a load hanging on a chain and a hook, by employing a sprocket built in a spherical helical gear driven by the rotational movement of a ring with internal spiral thread, coupled to a drive gear engaged by an drive chain pulled by an operator. An overload prevention and detection system provides safety against operator attempts to lift loads having weights over the capacity of the system.

### CROSS-REFERENCE TO RELATED APPLICATIONS

This application claims benefit of U.S. Provisional Patent Application Ser. No. 63/524,880, filed Jul. 4, 2023, the disclosure of which is incorporated herein by reference.

### BACKGROUND

This disclosure relates to hand-driven chain hoists, also known as manual chain hoists, used for lifting and lowering heavy loads.

It consists of a load chain, a drive chain, a set of gears, a lifting hook and a braking system to hold a load when hanged. The load chain is looped around a sprocket, and when the operator pulls on the drive chain, it engages the gears, disengaging a braking system, causing the sprocket to rotate. This rotation enables the chain hoist to lift or lower the load.

Hand-driven chain hoists are typically used in industrial settings, construction sites, workshops, warehouses, and other environments where heavy objects need to be lifted or moved. They are particularly useful when there is no power source or when the available space is limited for larger lifting equipment, such as cranes or forklifts.

These hoists are manually operated by pulling on the chain, which creates a mechanical advantage through a gear system. This allows the operator to lift heavy loads with less effort compared to lifting the load directly. The lifting capacity of a hand-driven chain hoist can vary, ranging from a few hundred kilograms to several tons, depending on the design and specifications of the specific hoist.

Current hand-driven chain hoist technology can also feature a load limit mechanical switch by means of a clutch on the operators, usually sold separately as an add-on feature. If the operator attempts to lift a load over the hoist load capacity then the clutch disks start to slip and the operator won't be able to transmit power through the drive gear up to the load chain sprocket. This load limit mechanical switch is costly and requires to be factory set by adjusting a locking nut torque when assembled.

Additionally, the operator can work around this overload protection system just by increasing an applied locking nut torque, and that won't stop an accident from occurring.

### SUMMARY

In accordance with the disclosure, a hanging hand-driven chain hoist for lifting, sustaining and lowering a load hanging on a chain and a hook, employs a sprocket built in a spherical helical gear driven by the rotational movement of a ring with internal spiral thread, coupled to a drive gear engaged by an drive chain that is adapted to be pulled by an operator. An overload prevention and detection system provides safety against operator attempts to lift loads having weights over the capacity of the system.

The subject matter of the present technology is particularly pointed out and distinctly claimed in the concluding portion of this specification. However, both the organization and method of operation, together with further advantages and embodiments thereof, may best be understood by reference to the following description taken in connection with accompanying drawings wherein like reference characters refer to like elements.

### BRIEF DESCRIPTION OF THE DRAWINGS

FIG. 1 is a front view of a LIFTING DEVICE in accordance with the invention;

FIG. 2 is a side view of the LIFTING DEVICE of FIG. 1;

FIG. 3 is a sectional view of the LIFTING DEVICE, taken along line 3-3 of FIG. 1;

FIG. 4 is a sectional view of the LIFTING DEVICE, taken along line 4-4 of FIG. 1; and

FIG. 5 is a sectional view of the LIFTING DEVICE, taken along line 5-5 of FIG. 1.

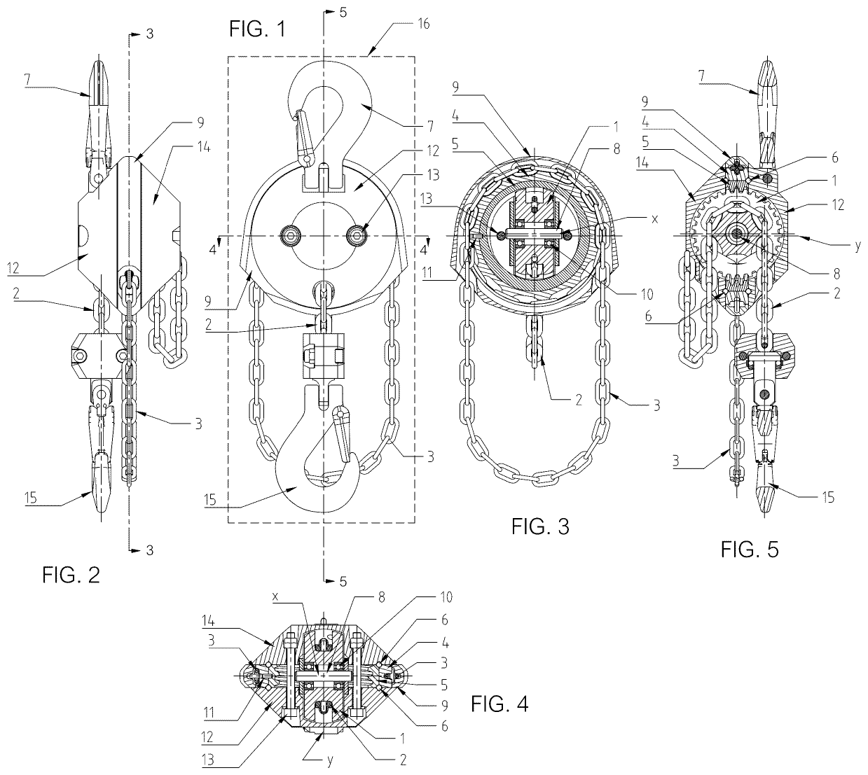

### DETAILED DESCRIPTION

The system according to a preferred embodiment of the present disclosure comprises lifting device

Referring to the drawings, the invention relates to a hand-driven chain hoist 16 having a compact construction, characterized by a sprocket built in a spherical helical gear 1, driven by the rotation of a ring with internal spiral thread 5. The spiral thread of the ring with internal spiral thread 5 engages with and drives the toothed spherical helical gear 1 when a rotational force is applied to the ring with internal spiral thread 5. When no rotational force is applied, the ring with internal spiral thread 5 is able to lock the rotation movement of the spherical helical gear 1 by the action of the frictional force resulting by the contact between the spiral thread of the ring with internal spiral thread 5 and the teeth of spherical helical gear 1.

The sprocket built in the spherical helical gear 1 engages a chain 2 that holds a load through a hook 15.

The ring with internal spiral thread 5 is assembled inside a drive gear 4. The spherical helical gear 1 rotates on a pair of bearings 10 mounted on a shaft 8. The shaft 8 is positioned on axis x. The ring with internal spiral thread 5 rotates together with the drive gear 4 by means of a pin 11. Both the ring with internal spiral thread 5 and the drive gear 4 rotate on axis y, orthogonal but not coplanar to axis x, by the of means ball sets 6 rolling on circular races placed on both planar faces of the ring with internal spiral thread 5 and the drive gear 4 also centered on axis y. The ball sets 6 are guided on outer fixed shells 12 and 14 circular races. Outer shells 12 and 14 are fixed together by fasteners 13. Outer shells 12 and 14 are characterized by providing a hole to guide the chain 2. The drive gear 4 engages the drive chain 3 guided by an outer ring 9. The drive gear 4 produces a shear cut on the pin 11 when a pulling force applied to the drive chain 3, required to lift a load, exceeds the pin 11 shear resistance and therefore the pin 11 will act as a fuse, preventing the hand-driven chain hoist 16 to be used over its maximum load capacity. The pin thus operates as an overload protection system.

Additionally, the pin system will provide the ability to detect and provide a clear notice of such overload use attempt, by the failure of the pin. From that point on, the hand chain hoist will become non functional and maintenance will be required. This provides an extremely safe system and keeps a company safe from the device misuse done by its employees.

The hand-driven chain hoist 16 is suspended on hook 7 mounted on the outer shell 12.

Accordingly, an improved lifting device is provided that does not require a load brake like the commonly known worm-drive classic systems, provided in an extremely compact design by comparison. An overload protection and detection system is provided to enhance safety from mis-use. The chain drive system does not require an additional brake to hold the load when the operator releases the driving chain, i.e., the load won't fall.

While a preferred embodiment of the technology has been shown and described, it will be apparent to those skilled in the art that many changes and modifications may be made without departing from the broader aspects. The appended claims are therefore intended to cover all such changes and modifications as fall within the true spirit and scope of the technology.

What is claimed is:

1. A manual chain hoist, comprising:
a sprocket in a spherical helical gear,
a ring with internal spiral threads;
wherein said sprocket is driven by said ring with internal spiral threads.

2. The manual chain hoist according to claim 1, further comprising a rotational drive gear, said ring with internal spiral threads rotating together with said rotational drive gear.

3. The manual chain hoist according to claim 2, further comprising an engagement pin for driving engagement between said rotational drive gear and said ring with internal spiral threads.

4. The manual chain hoist according to claim 3, wherein said pin is adapted to disengage from driving engagement between said rotational drive gear and said ring with internal spiral threads in the event of an overload condition.

5. The manual chain hoist according to claim 4, wherein said pin disengaging is caused by said pin breaking.

6. The manual chain hoist according to claim 2, further comprising a drive chain engaging said drive gear for allowing operator rotation of the drive gear.

7. The manual chain hoist according to claim 1, further comprising a load chain engaged with said sprocket in said spherical helical gear, said load chain for holding a load which said manual chain hoist is supporting.

8. The manual chain hoist according to claim 1, wherein said sprocket built in a spherical helical gear runs inside of said ring with internal spiral thread.
